(19) United States
(12) Patent Application Publication
(10) Pub. No.: US 2018/0025817 A1
(43) Pub. Date: Jan. 25, 2018

(54) CABLES HAVING COLORED JACKETS AND METHODS FOR SAME

(71) Applicant: General Cable Technologies Corporation, Highland Heights, KY (US)

(72) Inventors: Xi Zhang, Carmel, IN (US); Sathish Kumar Ranganathan, Avon, IN (US); Christopher C. Boller, Doral, FL (US); Alejandro Javier Soto Avello, Santiago (CL); Srinivas Siripurapu, Carmel, IN (US); Rogerio Silva Tocchetto, Doral, FL (US); Vijay Mhetar, Carmel, IN (US)

(21) Appl. No.: 15/656,773

(22) Filed: Jul. 21, 2017

Related U.S. Application Data
(60) Provisional application No. 62/365,456, filed on Jul. 22, 2016.

(51) Int. Cl. H01B 13/34; H01B 7/36

(52) U.S. Cl. CPC H01B 13/345; H01B 7/365; H01B 7/361

(57) ABSTRACT

Systems and methods to apply an on-demand color scheme to a cable are described. The systems and methods include the application of a plurality of colored coating fluids to an outer cable layer.

### REFERENCE TO RELATED APPLICATIONS

The present application claims the priority benefit of U.S. provisional application Ser. No. 62/365,456, entitled CABLES HAVING COLORED JACKETS AND METHODS FOR SAME, filed Jul. 22, 2016, and hereby incorporates the same application herein by reference in its entirety.

### TECHNICAL FIELD

The present disclosure generally relates to providing colored cables and colored outer jacketing for cables.

### BACKGROUND

Conventional cables are often colored in accordance with standard or custom color schemes, to facilitate ready identification of the cable in a particular application and/or for a particular purpose.

### SUMMARY

In accordance with one embodiment, a method of providing a colored cable coating to a cable includes selecting a desired cable coating color, dispensing, in response to the selecting operation, a plurality of colored coating compositions onto the cable, and drying the plurality of colored coating compositions to form the colored cable coating. The plurality of colored coating compositions form the desired cable coating color.

In accordance with another embodiment, a method of providing a colored cable coating to a cable includes selecting a desired cable coating color, providing a cable to an on-demand color coating system, dispensing a plurality of colored coating compositions onto the cable with the on-demand color coating system, and drying the plurality of colored coating compositions to form a colored cable coating. The on-demand color coating system includes a plurality of colored coating composition containers, an applicator unit fluidly connected to each of the plurality of colored coating composition containers, at least one valve disposed between the plurality of colored coating composition containers and the application unit, and a controller operable to actuate the at least one valve between the plurality of colored coating composition containers and the applicator unit. Each of the plurality of colored coating composition containers contains one of the plurality of colored coating compositions. The controller controls the dispensing of the plurality of colored coating compositions in response to the step of selecting the desired cable coating color. The plurality of colored coating compositions forms the desired cable coating color.

### BRIEF DESCRIPTION OF THE DRAWINGS

It is believed that certain embodiments will be better understood from the following description taken in conjunction with the accompanying drawings, in which:

FIG. 1 is a flow-chart depicting a methodology for coloring cables, in accordance with one embodiment;

FIG. 2 is a schematic view depicting a system for coloring cables, in accordance with a second embodiment;

FIG. 3 is a schematic view depicting a system for coloring cables, in accordance with a third embodiment;

FIG. 4 is a schematic view depicting a system for coloring cables, in accordance with a fourth embodiment;

FIG. 5 is a schematic view depicting a system for coloring cables, in accordance with a fifth embodiment; and

FIG. 6 is a schematic view depicting a system for coloring cables, in accordance with a sixth embodiment.

### DETAILED DESCRIPTION

As will be described more fully herein, systems and methods useful to facilitate application of an on-demand color scheme to a cable are disclosed. The color scheme can be selected and rapidly applied to a desired length of a cable through application of a colored coating or jacket. Generally, such systems and methods can operate through use of an in-line coloring station which can mix and apply a plurality of colored coating fluids to the cable.

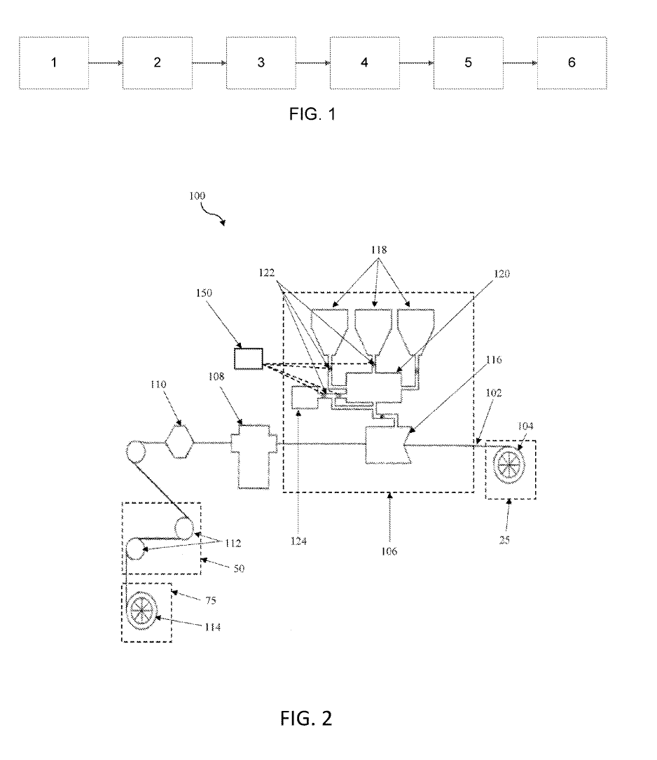

Selected methods and apparatuses in accordance with the present disclosure are now described herein in connection with the views and examples of FIGS. 1-6, wherein like numbers indicate the same or corresponding elements throughout the views.

FIG. 1 depicts a general methodology for application of an on-demand color scheme to a cable. The methodology can include the step of providing a cable (e.g., through a pay-out assembly) 1, application of the color scheme at a coloring station 2, application of a coating 3, curing of the color scheme and the coating 4, application of an exterior coating 5, and storing of the finished cable (e.g., at a take-up or pay-in assembly) 6. As can be appreciated, many modifications to this methodology are possible in various embodiments. For example, one or more steps, such as application of a coating 3 or application of an exterior coating 5, can be omitted in certain embodiments.

The general methodology depicted in FIG. 1 can be useful to apply a color scheme (e.g., an individual color, combination of colors, and/or different colored patterns) to any of a variety of cables. For example, suitable cables can be of a single conductor type, such that the jacket of the single conductor is the outer jacket of the cable. In other examples, the cable can be of a multi-conductor type, such that the outer jacket of the cable surrounds a bundle of two or more individually insulated electrical conductors (each, themselves, being a single conductor cable having a respective outer jacket). In other examples, the cable can also, or alternatively, include optical fibers, cable separators, or other cable elements known in the art. Additional insulation and jacket layers can also be included.

In certain embodiments, suitable cables can be building cable wires such as, for example, XHHW-2 or THEN building cable wires. As can be appreciated, users often desire such building cable wires to have custom color schemes which can be difficult to effectively store and provide on-demand particularly when only short cable lengths are needed. On-demand application of a coloring scheme using the systems and methods described herein can obviate such difficulty and can allow for efficient coloring of cables of any length.

Generally, the systems and methods described herein can apply a color scheme over any outer cable layer through application of appropriate colored coating fluids to the cable layer. For example, an ultraviolet (“UV”) curable colored coating fluid can coat cable jackets formed of one or more of cross-linked polyethylene (“XLPE”), polyvinyl chloride (“PVC”), and polyamide (e.g., nylon). Alternatively, suitable curable colored coating fluids can be formed of other curable compositions including, for example, moisture curable resins, heat curable resins, electron beam curable resins, or any other type of curable colored coating composition.

Generally, the colored coating fluids can include a colorant or pigment which facilitates formation of an on-demand colored coating. For example, the systems described herein can generally include colored coating fluids of a certain color model. In certain embodiments, CMY or CMYK color models can be selected. CMY and CMYK color models refer to the use of cyan, magenta, yellow, and optionally black colorants or pigments. In such color models, cyan, magenta, and yellow can be mixed to form any of a large number of colors. As can be appreciated, other primary colors can also, or alternatively, be provided to modify the color schemes that can be formed by altering, or expanding, the range of colors that can be formed from the selected color model.

Colorants and pigments can generally be selected based on the color of the outer cable layer that the colored coating fluids are applied to. For example, when the colored coating fluids are to be applied to a cable having a white-colored layer or jacket, organic colorants and pigments such as diazo-based and phthalic-based colorants can be selected because such colorants generally form translucent coatings. Alternatively, when the colored coating fluids are to be applied to a cable layers exhibiting any other color (including black cable jackets), inorganic colorants and pigments such as sulfide-based colorants can instead be used. Such inorganic colorants and pigments can be used to form opaque coatings which block transmission of the underlying cable layer color.

In certain embodiments, additional colored coating fluids can further be provided as spot colors. Spot colors refer to premixed colors that do not need to be formed by mixing primary colored coating fluids together. Spot colors can be useful to facilitate the application of frequently used color schemes or to apply color schemes which cannot be formed from the colored coating fluids used in the selected color model such as fluorescent coatings, UV or infrared coatings, temperature-sensitive coatings, and the like.

In certain embodiments, suitable UV curable colored coating fluids can include an acrylate resin, a crosslinking agent, a photoinitiator, the colorant and/or pigment, and modifiers such as viscosity modifiers and polymerization inhibitors. For example, suitable resins can include one or more polymers or oligomers of urethane, acrylate, and urethane acrylate (e.g., aliphatic urethane acrylate resin, isobornyl acrylate, 2-phenoxyethylene acrylate, isodecyl acrylate, etc. in certain embodiments). In such embodiments, suitable crosslinking agents can include diacrylates such as bisphenol-A epoxydiacrylate. Suitable UV photoinitiators can include trimethylbenzoyl diphenyl phosphine oxide, 2-isopropylthioxanthone, and 2-(dimethylamino)-1-(4-(4-morpholinyl)phenyl)-2-(phenyl methyl)-1-butanone. As can be appreciated, viscosity modifiers and polymerization inhibitors can be selected as known in the art. For example, viscosity modifiers such as N-vinyl-caprolactam, and organosilicones (e.g., polyalkyleneoxide modified polydimethylsiloxane) can be selected. An example of a suitable polymerization inhibitor is an aluminum salt such as N-nitroso-N-phenylhydroxylamine aluminum salt. In certain such embodiments, the UV curable colored coating fluid can include, by weight percentage, about 75% to about 99% of a resin, about 0.5% to about 5% of a crosslinking agent, about 1% to about 5% of a photoinitiator, about 0.5% to about 5% of a colorant or pigment, about 0.5% to about 6% of a viscosity modifier, and trace amounts of other components.

As can be appreciated however, other UV curable colored coating fluids as well as additional curable colored coating fluids are also known and can alternatively be used as the described systems and methods are not particularly limited by the choice of colored coating fluids. Generally, suitable colored coating fluids can be supplied to the described systems in a ready-to-cure state.

FIG. 2 illustrates a system 100 which provides at least some of the steps of the general methodology described in FIG. 1. For example, the system 100 of FIG. 2 illustrates the steps of providing a cable 1, application of the color scheme at a coloring station 2, curing of the color scheme 4, application of an exterior coating 5, and packaging of the finished cable 6. Other embodiments described herein illustrate additional, or alternative, steps such as application and curing of a coating.

Generally, the system 100 can comprise a dispenser 104, a coloring station 106, a curing station 108, a lacquering station 110, tensioners 112, and a winding spool 114. The cable 102 can initially be wound on the dispenser 104, from which the cable 102 can then be dispensed. In one embodiment, the dispenser 104 comprises an unwinding spool. The dispenser 104, the tensioners 112, and the winding spool 114 can cooperate to facilitate routing of the cable 102 through the coloring station 106, the curing station 108, and the lacquering station 110, at a desired speed and tension. It is to be appreciated that, although the dispenser 104 and the winding spool 114 are shown to be spools, any of a variety of suitable alternative arrangements can be provided that facilitate dispensation and collection, respectively, of a cable.

As illustrated in FIG. 2, the system 100 can, in more detail, comprise a pay-out assembly 25, a cable lag averting mechanism 50 and a pay-in assembly 75. The pay-out assembly 25 can include the dispenser 104, the cable lag averting mechanism 50 can include the tensioners 112 (e.g., pulleys, accumulators and/or dancers), and the pay-in assembly 75 can include the winding spool 114. The pay-out assembly 25 can additionally include a motor (not shown) that controls rotation of the dispenser 104 as the cable 102 is dispensed from the dispenser 104 and into the coloring station 106. Likewise, the pay-in assembly 75 can additionally include a motor (not shown) that controls rotation of the winding spool 114 as the cable 102 is collected onto the winding spool 114 from the coloring station 106.

A control system can be coupled with, and configured to control the torque and speed of, the motors of the pay-out assembly 25 and the pay-in assembly 75. The control system can be further coupled with the tensioners 112 of the cable lag averting mechanism 50. By controlling the speed and torque of both the dispenser 104 of the pay-out assembly 25 and the winding spool 114 of the pay-in assembly 75, and through operation of the cable lag averting mechanism 50, a desired speed and tension of the cable 102 through the system 100 can be established and maintained. Undesired sagging or snapping of the cable 102 can accordingly be prevented. In one embodiment, the dispenser 104 rotates at a slower speed than the winding spool 114 to create tension in the cable 102, which resists or prevents sagging of the cable 102.

The coloring station 106 can be configured to selectively incorporate a color scheme into the jacket of the cable 102. This can be achieved through any of a variety of suitable processes, a few embodiments of which are described herein with specific reference to the respective FIGS. 2-6.

In a first embodiment, the color scheme can be incorporated into the outer layer of the cable 102 by applying a colored coating fluid onto the cable 102. The fluid can be a UV curable resin, a moisture curable resin, a heat curable resin, or any other type of curable colored coating fluid.

With reference to FIG. 2, the coloring station 106 can comprise a die unit 116, a plurality of hoppers 118 (three shown), and a mixer 120, which can be coupled together by a plurality of passageways. Valves (e.g., 122) can be provided such as to selectively block or facilitate passage of materials through corresponding passageways, as desired.

It is to be appreciated that the quantity and configuration of hoppers, passageways and valves can vary among any of a variety of suitable quantities and configurations, and there can be more than one of each. For example, the quantity and configuration can vary depending on the selected color model. In certain embodiments including a CMY or CMYK color model for example, 3 or 4 hoppers can be included to provide cyan, magenta, yellow, and optionally black colored coating fluids. Additionally, it can be useful in certain embodiments to include further hoppers, passageways, and valves for spot colors.

The die unit 116 can include at least one die head (not shown) having an annulus or channel (not shown) through which the cable 102 is passed and at least one aperture (not shown) through which the colored coating fluid is applied onto the cable 102. Different colored coating fluids can be provided into each of the respective hoppers 118 of the coloring station 106. In such a configuration, the coloring station 106 can be configured to selectively transfer the colored coating fluid from the respective hoppers 118, in a desired selection and quantity, to the mixer 120, such as through use of the passageways and valves (e.g., 122). The mixer 120 can be configured to then combine the different colored coating fluids from respective hoppers 118 to achieve a desired color scheme for the outer layer of the cable 102. As can be appreciated, the desired quantity of colored coating fluid can be selected by either transferring a discrete quantity of the colored coating fluid or by controlling the flow rate of the colored coating fluid out of a hopper 118.

A controller 150 can be in communication with the coloring station 106, and with particular components of the coloring station such as the valves 122, to facilitate selection (e.g., by a user) of the color scheme to be applied to or as the outer layer of the cable 102. It is to be appreciated that the controller 150 can comprise a general purpose computer, a programmable logic controller, discrete analog and/or digital control devices, and/or any of a variety of other suitable user controllable arrangements to facilitate on-demand selection of a color scheme by a user for an outer layer of the cable 102.

In one example, primary colored coating fluids (e.g., cyan, magenta, and yellow) can be provided within one of the respective hoppers 118. The controller 150 can facilitate selective operation of the plurality of valves (i.e., 122) to facilitate or encourage flow of predetermined or specific amounts of one or more of the primary colored coating fluids from one or more of the three hoppers 118, through the respective passageways, and into the mixer 120, in order to achieve a specific desired color of fluid being provided by the coloring station 106 onto the cable 102. Once mixed by the mixer 120 into the desired color, the fluid is transferred from the mixer 120 to the die head of the die unit 116, for application and resultant coloring of the cable 102. It will accordingly be appreciated that, by opening and closing appropriate ones of the valves (e.g., 122), the controller 150 can quickly, efficiently, and easily select (and, as desired, change) the color of an outer layer of cable produced by the system 100, in response to a simple instruction from a user, and without requiring any complex reconfiguration of the system 100. Accordingly, in this manner, the system can facilitate on-demand manufacturing of cables of different colors. In one embodiment, the system 100 can facilitate selection by a user of from among about 64,000 available colors and/or color schemes.

The curing station 108 can be configured to cure the colored coating fluid applied to the cable 102. In one embodiment, the curing station 108 can comprise a UV curing station having a UV lamp (not shown). In such a configuration, the fluid applied to the cable by the coloring station 106 can comprise a UV reactive colored coating fluid. The UV lamp of the curing station 108 can be configured to cure, or begin curing, the colored coating fluid applied to the cable 102, as the cable 102 passes through the curing station 108. In such an embodiment, the curing time can be dependent upon the type and quantity of colored coating fluid applied to the cable 102, the speed at which the cable 102 passes through the curing station 108, as well as the type of UV lamp used. In some embodiments, the UV reactive fluid can be cured in between about 1 second to about 2 minutes. In some embodiments, the curing station 108 can operate at a line speed of about 200 feet per minute. In other embodiments, the curing station 108 can operate at a line speed of about 1,000 feet per minute.

It is to be appreciated that the UV lamp of the UV curing station can comprise any of a variety of suitable types of UV lamps, such as, for example, UV microwave lamps, UV LED lamps, and UV arc lamps, which can include mercury vapor lamps (also known as H-type lamps), mercury vapor lamps with an iron additive (also known as D-type lamps), mercury vapor lamps with a gallium additive (also known as V-type lamps), and mercury vapor lamps with an indium additive (also known as Q-type lamps). In alternative embodiments, colored coating fluid applied to the cable 102 can additionally or alternatively be cured with heat, flame, radiation, moisture, electron beams, and/or other sources of energy.

The lacquering station 110 can be configured to apply a coat of a lacquering fluid (e.g., lacquer or other type of suitable fluid) onto the cable 102 once the colored coating fluid has been applied thereto. This lacquering fluid can maintain the integrity of the applied colored coating fluid, as well as provide an abrasion-resistant, glossy, varnished appearance to the cable 102. In some embodiments, the lacquering fluid can be formed of a thermosetting polymer, a polyurethane lacquer, or a polyesteramide lacquer. In some embodiments, the lacquering fluid can include a UV barrier such as polyurethane, which can resist external UV from later deteriorating the cable 102 in use. In some embodiments, once the lacquering fluid is applied to the cable 102, it can be passed through a conveying area where it is air dried. Once the lacquering fluid has been applied, the cable 102 can then be collected onto the winding spool 114. It will be appreciated that, in some embodiments, a curing station 108 and/or a lacquering station 110 might not be provided.

In certain embodiments, the lacquering station 110 can alternatively be configured to apply other external coating compositions. For example, an icephobic coating composition or anti-friction coating could alternatively be applied. In still other embodiments, more than one lacquering station 110 can be included to apply a plurality of external coating compositions.

The coloring station 106 is shown to include a solvent container 124 that contains a solvent which can be selectively introduced into the system 100 (e.g., by a valve 122, controller 150, and passageway(s)) to facilitate cleaning of any or all of the components of the coloring station 106, and also potentially to facilitate cleaning of one or more other components of the system 100. The solvent stored in the solvent container 124 can be selected on the basis of its capability to dissolve or remove the colored coating fluid and/or other fluid introduced to the cable 102 by the system 100. In certain embodiments, a waste container (not shown) can be included to store used solvent.

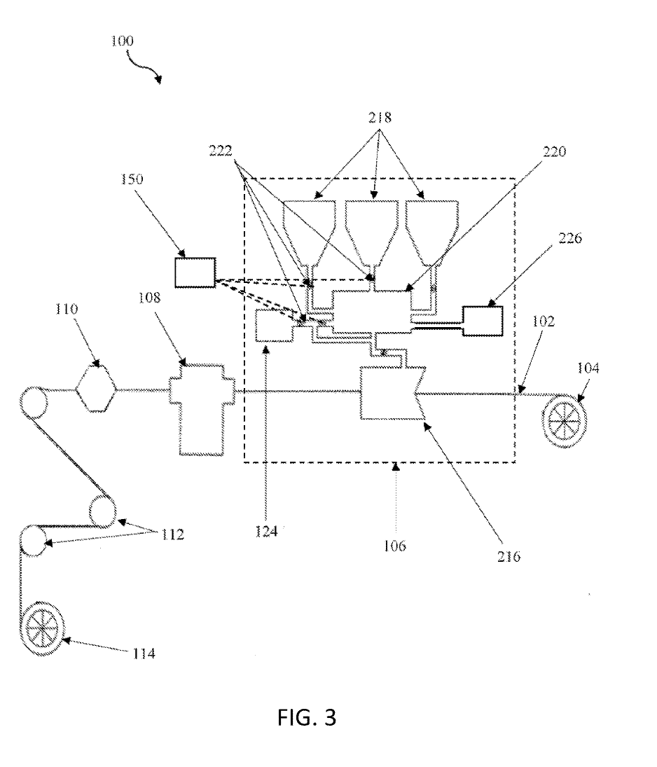

Another embodiment of the system 100 is illustrated in FIG. 3, which it will be appreciated can be similar to or the same in many respects as the system 100 of FIG. 2, except as noted in relevant part below. More particularly, the coloring station 106 of FIG. 3 is shown to comprise a die unit 216, a plurality of hoppers 218, a mixer 220, a coating container 226, and a plurality of valves 222, coupled together by a plurality of passageways. The hoppers 218 can contain different colored coating fluids (e.g., cyan, magenta, and yellow). The coating container 226 can contain a coating resin. In one embodiment, the coating resin can comprise an acrylate resin of a neutral color such as white or can be translucent. As can be appreciated however, the coating resin contained in the coating container 226 can alternatively be stored and dispensed from the plurality of hoppers 218.

The controller 150 can be configured to operate valves 222 such that resin from the coating container 226 is introduced into the mixer 220 where it can be mixed together with one or more colored coating fluids from one or more of the hoppers 218. More particularly, the mixer 220 can be configured to mix the colored coating fluid(s) from the hoppers 218 with the resin from the coating container 226 to produce a selected color for application to the cable 102. It will be appreciated that, by providing a neutral colored resin within the coating container 226, the coloring station 106 of FIG. 3 can potentially achieve a greater variety of color selection for application to the cable than can be achieved with the coloring station 106 of FIG. 2.

In certain embodiments, the controller can be used to calibrate the color scheme. For example, the controller can be manually adjusted by a user or can include a color sensor to determine any variance between the selected color and the color scheme applied to a cable.

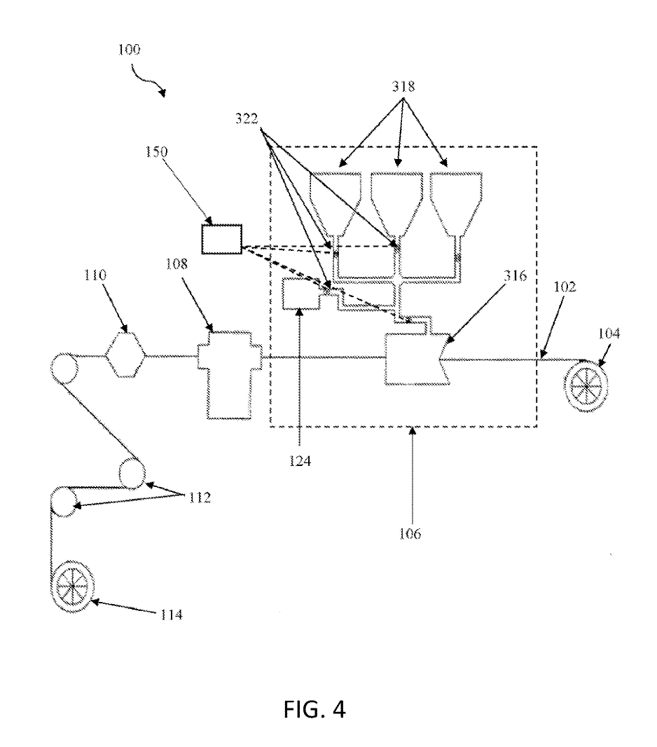

Another embodiment of the system 100 is illustrated in FIG. 4, which it will be appreciated can be similar to or the same in many respects as the system 100 of FIG. 2, except as noted in relevant part below. For example, the coloring station 106 can comprise a die unit 316, a plurality of hoppers 318, and a plurality of valves 322, coupled together by a plurality of passageways. However, the system 100 of FIG. 4 is devoid of a mixer (e.g., 120 in FIG. 2), such that fluids respectively dispensed from the hoppers 318 and the solvent container 124 are mixed together at their intersection, such as within the passageways and/or within the die unit 316 itself

The die unit (e.g., 116, 216, 316) can be provided in any of a variety of suitable configurations. In one embodiment, the die unit can be configured in use to always provide a uniform color application about an entire circumference of the cable 102, e.g., to result in the cable 102 having a solid, uniform color along its entire length. For example, the die unit can have a rotating die head and a manifold configured to provide uniform distribution of color from apertures of the die onto the cable 102. However, in another embodiment, the die unit can be configured (e.g., split, moveable, rotatable or otherwise) in use to provide a variable color application about a circumference of the cable 102, e.g., such as to facilitate striping or other patterns (e.g., with more than one color provided simultaneously or in an alternating pattern) on an exterior of the cable 102.

In some embodiments, the die head can be removable to facilitate cleaning and/or replacement of the die or other components. In some embodiments, the die head can be adjustable or replaceable to accommodate cables of different diameters.

In some embodiments, the die head can be configured to automatically adjust the diameter of its orifice to accommodate cables with different diameters. In another embodiment, the die head can be configured to control the overall temperature imparted to the fluid.

In some embodiments, a coloring station can include an additional die unit (not shown) having at least one die configured to apply at least one more layer of colored coating fluid coating on the cable before or after drying of one or more previously applied colored coating fluid coatings that had previously been applied onto the cable (e.g., by the die unit 116, 216, or 316). In certain embodiments, a coating composition can additionally, or alternatively, be applied.

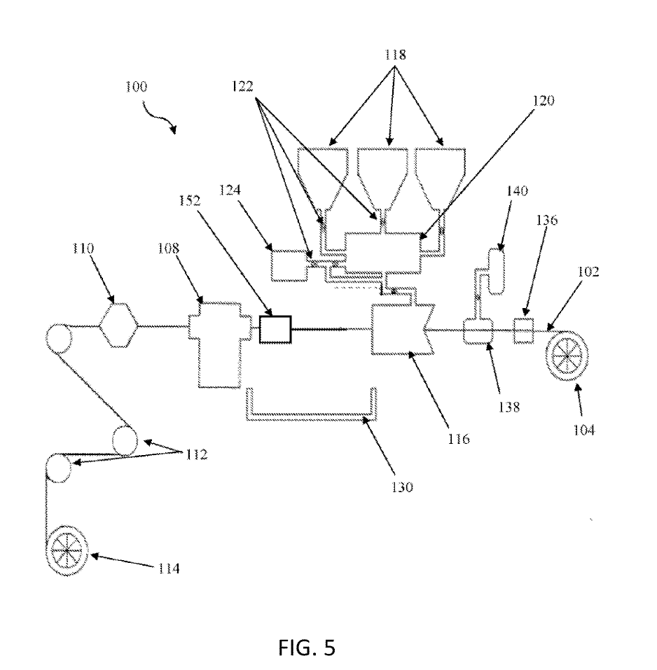

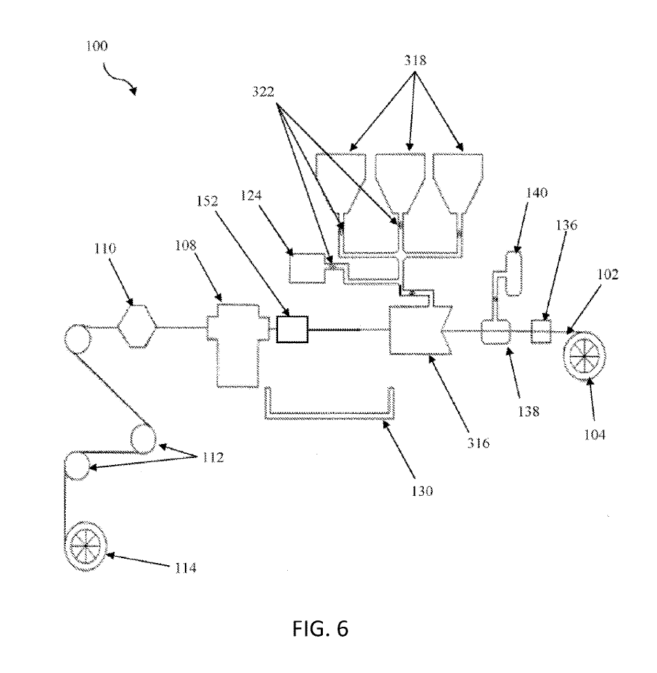

Other embodiments of the system 100 are illustrated in FIGS. 5 and 6, which it will be appreciated can be similar to or the same in many respects as the systems 100 of FIGS. 2 and 4 respectively, except as noted in relevant part below.

In some embodiments, after the cable 102 is dispensed from the die unit (e.g., 116, 216, 316), the cable 102 can be provided through a conveying area with a drip tray 130 (FIGS. 5 and 6) that underlies the die unit to collect and contain any excess fluid imparted to the cable 102.

In other embodiments, the system 100 can be configured to remove excess coating applied to the cable 102, thereby providing a uniform, relatively thin coating. For example, the system 100 can comprise an air wiping unit 152 (FIGS. 5 and 6) that is upstream of the curing station 108. The cable 102 can pass through a channel of the air wiping unit 152, whereby air (e.g., dry air) can be blown onto the cable 102 to dry and facilitate uniform adhesion of the colored coating fluid onto the cable 102. In other embodiments, colored coating fluid can be efficiently and uniformly applied on a cable by one or more of a dipping mechanism, spraying mechanism, squeegee, flooded die, and screen printing mechanism.

In still another embodiment of the present disclosure, the system 100 can comprise at least one sensor (not shown), such as an optical detector, for example, that is configured to detect non-uniformities such as, for example, gaps, holes, incorrect colors, or white spots, in the coating applied the cable 102 and transmit a signal based upon the non-uniformity. The controller 150 of the system 100 can be configured to correct the detected non-uniformity based upon the signal from the sensor. For example, to effect this correction, the controller 150 can be configured to receive the signal and to effect an automatic adjustment of the valves (e.g., 122), the die unit (e.g., 116), the mixer (e.g., 120), and/or the line speed of the cable 102 through the system 100.

In some embodiments, the colored coating fluid applied onto the cable 102 can comprise a UV curable fluid (e.g., color, ink, and/or paint). The UV curable fluid can include additives that are resistant to external UV degradation and thus prevent the colored coating fluid from becoming delaminated from the cable 102. In some embodiments, the UV curable fluid can comprise a moisture barrier.

In some embodiments, the system 100 can additionally include a buffing unit 136 (FIGS. 5 and 6) through which the cable 102 can be passed before the cable 102 enters the coloring station 106. The buffing unit 136 can be configured to prepare the surface of the cable 102 (e.g., through scraping or cleaning), such as to roughen or otherwise enhance it to facilitate effective gripping of the color to be applied on the cable 102. In some embodiments, the buffing unit 136 can be configured to remove oil and grease from the cable 102, and/or to anneal the cable 102. In some embodiments, the buffing unit 136 can be configured to facilitate surface treatment of the cable 102 through use of plasma, flame or corona to produce a desirable and reproducible surface finish with improved corrosion resistance, to alleviate contamination, and/or to provide surface roughness.

In some embodiments, as illustrated in FIGS. 5 and 6, the system 100 can include a pre-applicator 138 through which the cable 102 is passed before the cable 102 enters the coloring station 106. The pre-applicator 138 can be configured to apply a primer coat on the cable 102, such as to enhance subsequent application and/or adhesion of colored coating fluid onto the cable 102. The primer can be stored in a primer container 140 from which it is dispensed to the pre-applicator 138 via a passageway. Alternatively, a pre-applicator 138 can mechanically prepare a cable through a mechanical brush treatment, solvent cleaning treatment, or the like.

In some embodiments, the system 100 can include a printing station (not shown) that is configured to print indicia on the cable 102, e.g., once the cable 102 has been lacquered and cured, just prior to collection on the winding spool 114. It is to be appreciated that the indicia printed on the cable 102 can be accomplished through any of a variety of ink types and processes which can include translucent, opaque, laser-applied, thermally-applied, mechanically-applied, UV reactive, or the like. The indicia can provide product information such as relating to the manufacturer, type, specification, and/or rating of the cable 102, for example.

In some embodiments, just prior to collection on the winding spool 114, or after collection on the winding spool 114, the cable 102 can be subjected to an abrasion test (e.g., a cross-hatch test) in an attempt to assess how well the cable 102 withstands abrasive environments. Additionally or alternatively, at that time, the cable 102 can be subjected to a water ageing test in which the cable 102 is kept dipped inside salt water for a pre-determined time interval. These tests can, in part, reveal the durability and resilience of the color applied to the cable 102.

It will be appreciated that the systems and methods disclosed herein can provide significant benefits to a manufacturer, distributor, and end user of cables. Conventional cables are often colored in accordance with standard or custom color schemes, to facilitate ready identification of the cable in a particular application and/or for a particular purpose. The amount of cable to be manufactured and inventoried of any particular color or color scheme depends upon the estimated requirements of that particular cable within a particular time frame. However, incorrect estimations can lead to problems. For example, excessively high estimations can lead to excessive inventory, resulting in excessive cost and storage space, or resulting in inadequate manufacture and inventory of other important product. Excessively low estimations, on the other hand, can result in delay of product delivery to consumers, resulting in strained relationships, project delays, and associated time and cost inefficiencies. It can be challenging to estimate effectively, even for cables having one of the more common cable colors like red, yellow, green, blue, and black. However, the challenge to estimate effectively can be even further increased with respect to cables having a less common cable color and/or color scheme such as, for example, pink, multi-colored striped, or otherwise. In addition, especially with respect to these less common colors and/or color schemes, manufacture can be relatively difficult and/or expensive due to the relatively small quantity desired to be manufactured and/or inventoried on-hand.

By offering flexibility, convenience and cost efficiency in the manufacturing and coloring of cable such as to meet demand of customers (e.g., “on-demand”), it will be appreciated that the present disclosure can be useful in overcoming or addressing some or all of the foregoing challenges of conventional cable manufacture and distribution. It will accordingly be appreciated that cables manufactured and inventoried according to the present disclosure can achieve reductions in manufacturing time and cost, as well as reductions in product storage and delivery time, while facilitating improvements in efficiency and customer satisfaction.

The embodiments herein and the various features and advantageous details thereof are explained with reference to the non-limiting embodiments in the present description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice these embodiments. Accordingly, the examples should not be construed as limiting the scope of the embodiments herein.

The foregoing disclosure has been described with reference to the accompanying embodiments which do not limit the scope and ambit of the disclosure. The description provided is purely by way of example and illustration.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

The foregoing description of the specific embodiments so fully revealed the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method of providing a colored cable coating to a cable comprising:
selecting a desired cable coating color;
dispensing, in response to the selecting operation, a plurality of colored coating compositions onto the cable, the plurality of colored coating compositions forming the desired cable coating color; and
drying the plurality of colored coating compositions to form the colored cable coating.

2. The method of claim 1, wherein the plurality of colored coating compositions are applied substantially simultaneously onto the cable.

3. The method of claim 1, wherein the plurality of colored coating compositions are mixed before dispensing of the plurality of colored coating compositions.

4. The method of claim 1, wherein the plurality of colored coating compositions are applied sequentially.

5. The method of claim 4, wherein each colored coating composition of the plurality of colored coating compositions is applied as a different layer.

6. The method of claim 1, wherein the plurality of colored coating compositions comprises a cyan coating composition, a magenta coating composition, and a yellow coating composition.

7. The method of claim 6, wherein the plurality of colored coating compositions further comprises one or more of a black coating composition, a white coating composition, a translucent coating composition, a fluorescent coating composition, a spot-colored composition, an ultraviolet-sensitive coating composition, an infrared-sensitive coating composition, and a temperature-sensitive coating composition.

8. The method of claim 1, wherein the drying operating comprises curing of the colored cable coating with one or more of ultraviolet energy, heat, and moisture.

9. The method of claim 1, further comprising dispensing at least one exterior coating after drying of the plurality of colored coating compositions, the at least one exterior coating comprising one or more of a lacquer coating, an anti-stick coating, and an icephobic coating.

10. The method of claim 1, wherein each colored coating composition of the plurality of colored coating compositions comprises an organic colorant or pigment and wherein the colored cable coating is transparent.

11. The method of claim 1, wherein each colored coating composition of the plurality of colored coating compositions comprises an inorganic colorant or pigment and wherein the colored cable coating is opaque.

12. The method of claim 1, further comprising determining a selection and a quantity of each colored coating composition of the plurality of colored coating compositions in response to the selecting operation.

13. The method of claim 1, further comprising the application of indicia to the cable.

14. The method of claim 1, further comprising applying a pre-treatment to the cable jacket prior to the dispensing operation, wherein the pre-treatment comprises one or more of a primer and a mechanical treatment.

15. The method of claim 1, wherein the plurality of colored coating compositions is dispensed onto a cable jacket comprising one or more of cross-linked polyethylene, polyvinyl chloride, and a polyamide.

16. The method of claim 1, wherein each colored coating composition of the plurality of colored coating compositions comprises:
an acrylate resin;
a crosslinking agent;
an ultraviolet photoinitiator; and
one or more of a colorant and pigment.

17. The method of claim 1, wherein the cable is a XHHW-2 or THHN building wire.

18. A method of providing a colored cable coating to a cable comprising:
selecting a desired cable coating color;
providing a cable to an on-demand color coating system, the on-demand color coating system comprising:
a plurality of colored coating composition containers, each containing one of a plurality of colored coating compositions;
an applicator unit fluidly connected to each of the plurality of colored coating composition containers;
at least one valve disposed between the plurality of colored coating composition containers and the applicator unit; and
a controller operable to actuate the at least one valve between the plurality of colored coating composition containers and the applicator unit;
dispensing the plurality of colored coating compositions onto the cable with the on-demand color coating system, the plurality of colored coating compositions forming the desired cable coating color; and
drying the plurality of colored coating compositions to form a colored cable coating; and
wherein the controller controls the dispensing of the plurality of colored coating compositions in response to the step of selecting the desired cable coating color.

19. The method of claim 18, wherein the applicator unit comprises one of a flooded die and a spray head.

20. The method of claim 18, wherein the applicator unit provides variable application of the plurality of colored coating compositions.
